(19) United States
(12) Patent Application Publication
(10) Pub. No.: US 2011/0248039 A1
(43) Pub. Date: Oct. 13, 2011

(54) EATING APPLIANCE AND METHOD OF MAKING THE SAME

(76) Inventor: Steven Fellenzer, Centerville, OH (US)

(21) Appl. No.: 12/757,414

(22) Filed: Apr. 9, 2010

(51) Int. Cl. B65D 8/04; B23P 17/00

(52) U.S. Cl. 220/607; 29/419.1

(57) ABSTRACT

An eating appliance includes a swatch of a preformed carbon fiber resin of a predetermined size shaped and which is thermally permanently formed into an eating appliance shape to have a concave portion having a bottom and upwardly extending wall portion therefrom which terminates into a peripheral edge and wherein the peripheral wall has a reinforcing or decorative member connected to the peripheral edge. A method of forming the eating appliance is provided.

### FIELD OF INVENTION

The present invention relates to the field of eating appliances. More particularly, the invention relates to an eating appliance and method of making the same.

### BACKGROUND OF THE INVENTION

Eating appliances include a variety of dishware which includes plates, platters, cups, saucers, vases, jars, bowls, breakfast, tea and dinner sets. Plates for serving food come in a variety of sizes, from small saucers, to bread and butter plates, to dinner plates, to large platters. Some plates are made as decorative items for display rather than used for food. Plates have been made from ceramic materials such as bone china, porcelain and stoneware as well as other materials like plastic or glass, wood or carved stone. Disposable plates are often made from paper. Recently, melamine resin or tempered glass such as Corelle has been used.

Chinaware, or porcelain, and pottery are all made of clay, shaped and then fired or burned, but they are otherwise quite different from one another, both in substance and in the way they are made. These dishes are of the type vitreous “glassy”, semi-vitreous and earthenware or pottery. Chinaware includes vases, jars, bowls, breakfast, tea and dinner sets. The most desirable fine china is made by using fine workmanship and is fired at very high temperature. While chinaware can be fashioned in a variety of shapes, it has desirable properties such as being providing a beautiful finish with quasi-translucency and exhibiting a ringing sound, it is very fragile.

Clay has always been the chief ingredient of porcelain. Other materials are used with clay which includes feldspar, ground quartz, calcium carbonate in the form of chalk, and sometimes calcium phosphate in the form of bone ash. The kaolin, or china clay, does not melt and become transparent, but some of the other things, such as the feldspar, do. The surface of the clay has included painted metals, such as gold and silver on the surface to add decorative features.

There is a desire to provide an eating appliance, namely dishware, cup and saucer, for example, which is aesthetically pleasing to the eye and yet extremely durable. The present invention achieves this.

### SUMMARY OF THE INVENTION

It is an object to improve eating appliances.

It is another object to improve dishware including plates, platters, cups, saucers, vases, jars, bowls, breakfast, tea and dinner sets.

It is another object to improve the strength of dishware.

It is still another object to provide an eating appliance with improved strength and aesthetics.

Accordingly, the present invention is directed to a swatch of a preformed carbon fiber resin of a predetermined size shaped and which is thermally permanently formed into an eating appliance shape in a manner to have a generally smooth resin formed outer surface and inner carbon fiber member and configured to have a concave portion having a bottom and upwardly extending wall portion which terminates into a peripheral edge. The peripheral wall can have a reinforcing and or decorative member connected to the peripheral edge. The peripheral edge can be treated in a manner to provide a strengthened edge.

The reinforcing and or decorative member can preferably include a continuous rigid loop member. The reinforcing and or decorative member may be a metal member which can preferably be a polished external surface. The eating appliance includes dishware including plates, platters, cups, saucers, vases, jars, bowls, breakfast, tea and dinner sets, for example.

One aspect of the invention is directed to a process of making an eating appliance, which comprises the steps of:

(a) providing a swatch of carbon fiber of a predetermined size;

(b) inserting the swatch of preformed carbon fiber resin in a shaping mold having a male member and a female member which when operably connected to one another define a predetermined eating appliance shape which defines an inner wall, and which is further characterized such that a peripheral edge of the carbon fiber of the swatch is generally maintained in a spaced relation relative to the inner wall;

(c) applying heat to the swatch for a predetermined period while in the mold to cause the swatch to undergo a thermal reaction thereby causing resin to expand from the carbon fiber and contact the inner wall such that the swatch is permanently formed into the eating appliance shape; and

(d) removing the permanently formed eating appliance shaped swatch from the mold. The process can further include (e) treating a peripheral edge of the permanently formed eating appliance shaped swatch in a manner to provide the swatch with an enhanced edge. The step (e) can be further characterized to include trimming the peripheral edge and affixing reinforcing and or decorative member to the peripheral edge either by inserting member into the mold prior to heating or subsequently by using an adhesive. The reinforcing and or decorative member can be a continuous loop member. The reinforcing and or decorative member can include a metal member which can include a polished external surface. The process can include the step of compressing the swatch prior to performing step (c). The process wherein step (c) is heated to a temperature between about 200° C. to 400° C. for a period of about between 1 to 5 minutes.

### BRIEF DESCRIPTION OF THE DRAWINGS

FIG. 1 depicts a perspective view of a part of the invention.

FIG. 2 depicts a top plan view of FIG. 1.

FIG. 3 depicts a bottom plan view of FIG. 1.

FIG. 4 depicts a side view of FIG. 1.

FIG. 5 depicts a part cross-sectional view through line 5-5 of FIG. 2.

FIG. 5A depicts a partial blown up section of FIG. 5.

FIG. 6 depicts a perspective view of another part of the invention.

FIG. 6A depicts a unique cross hatched design seen through a translucent outer smooth covering of the part in FIG. 6.

FIG. 7 depicts a top plan view of FIG. 6.

FIG. 8 depicts a bottom plan view of FIG. 6.

FIG. 9 depicts a side view of FIG. 6.

FIG. 10 depicts a part cross-sectional view through line 10-10 of FIG. 7.

FIG. 11 depicts a perspective view of a part of the invention.

FIG. 12 depicts a top plan view of FIG. 11.

FIG. 13 depicts a bottom plan view of FIG. 11.

FIG. 14 depicts a side view of FIG. 11.

FIG. 15 depicts a part cross-sectional view of FIG. 14.

FIG. 16 depicts a step in the manufacture of the instant invention.

FIG. 17A depicts a second step in the manufacture of the instant invention.

FIG. 17B depicts a mold for use in the invention.

### DETAILED DESCRIPTION OF THE INVENTION

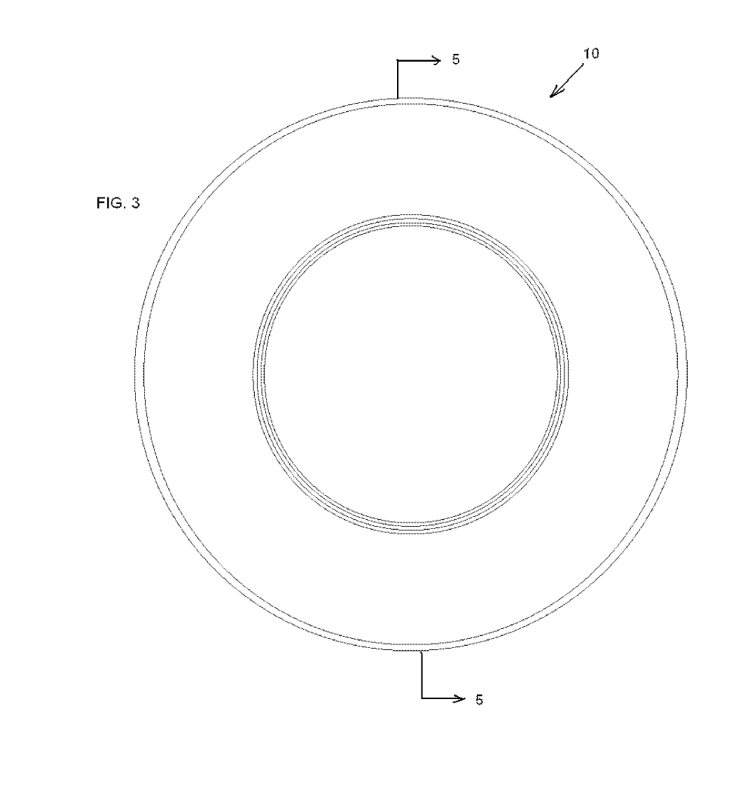

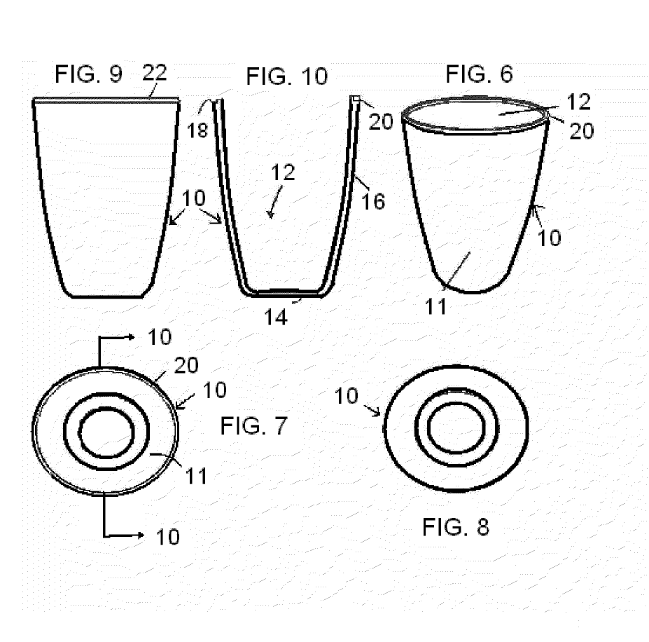

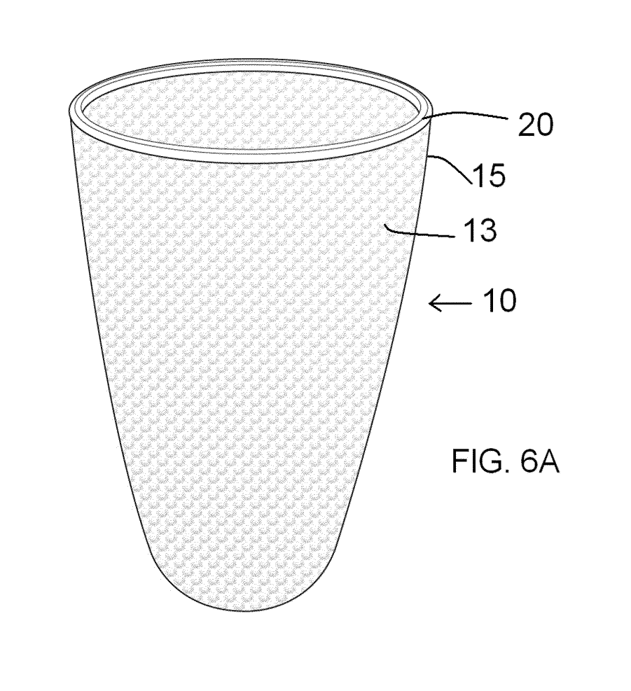

Referring now to the drawings, an eating appliance of the instant invention is generally designated by the numeral 10. The eating appliance 10 includes a swatch 11 of a preformed carbon fiber resin of a predetermined size shaped and which is thermally permanently formed into an eating appliance shape to have a concave portion 12 having a bottom 14 and upwardly extending wall portion 16 which terminates into a peripheral edge 18. In a preferred embodiment, the swatch 11 includes carbon fiber 13 impregnated with resin 15 which is thermally activated. It is also contemplated that the resin 15 can be added to a carbon fiber swatch and then the curable resin 13 may be thermally activated. The resin 15 can be cured with second heat and second pressure for about 5 minutes to about 60 minutes. Thus there is provided a finished composite panel which has a substantially transparent outer resin layer over the carbon fiber mat, and at least portions of the fiber mat are visible through the resin layer. The composite panel is substantially free of fiber readout. The thickness of the composite panel may range from about 1.0 mm to about 3.0 mm. It is envisioned that an exterior surface 13 of the swatch 11 can be formed to have an appearance which is at least partially glossy translucent showing an inner crosshatch pattern of the fiber swatch which provides unique aesthetic and strength features as seen in FIG. 6A. It is contemplated that other configurations may be derived.

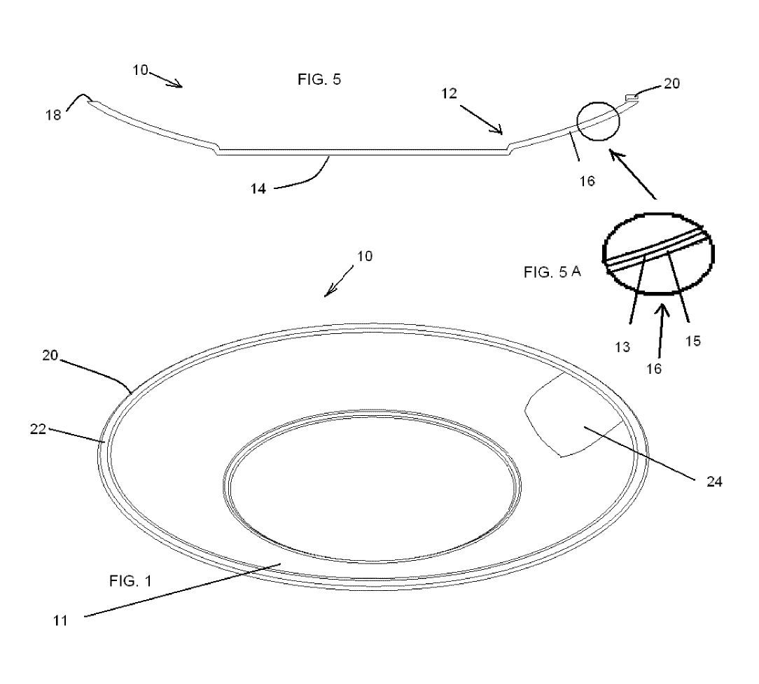

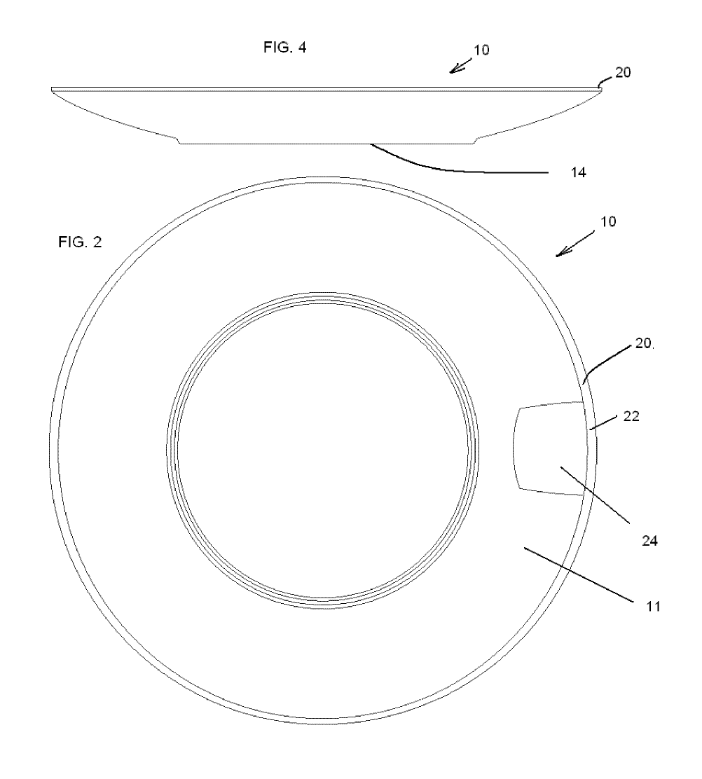

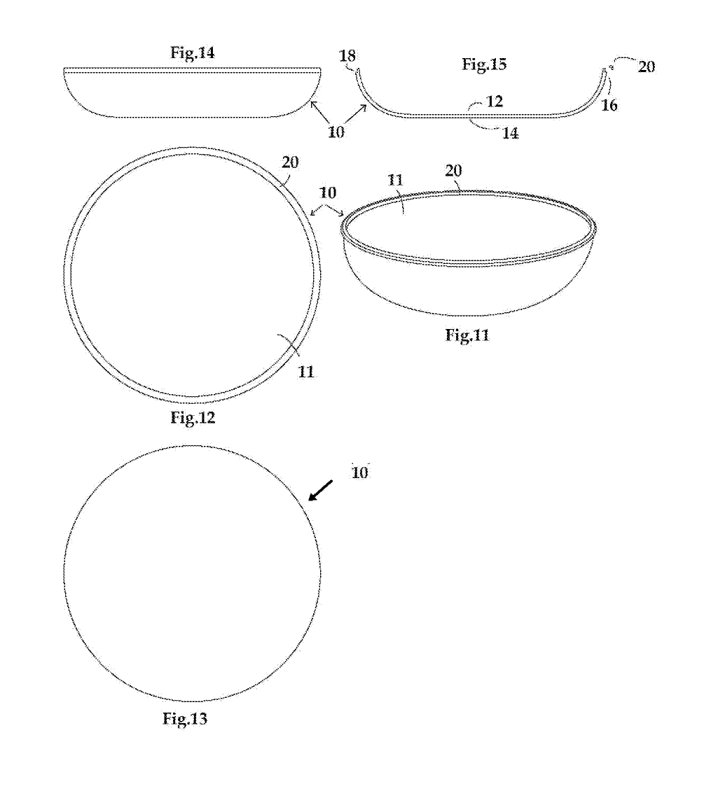

The peripheral edge 18 can be treated in a manner to provide an enhanced edge. In this regard, the peripheral wall portion 16 preferably can have a reinforcing and or decorative member 20 connected to the peripheral edge 18. The reinforcing and or decorative member 20 can be affixed to the peripheral edge 18 by way of insertion during the molding process or subsequent adhering with adhesive, for example. The reinforcing and or decorative member 20 can be in the form of a continuous loop member, but other configurations are contemplated within the scope of the invention. In the embodiment depicted, the continuous loop reinforcing and or decorative member 20 can include a metal ring of a desired thickness. To provide aesthetic appeal, the reinforcing and or decorative member 20 can include a polished external surface 22. An emblem 24 can also be provided which can be integral with the member 20 or separate and can likewise be formed during or after the molding process in a manner to be inwardly or externally disposed as desired for functional and aesthetic reasons. The eating appliance 10 can include a variety of configurations, such as plates, platters, cups, saucers, vases, jars, bowls, breakfast, tea and dinner sets wherein FIGS. 1-15 depict two exemplary versions.

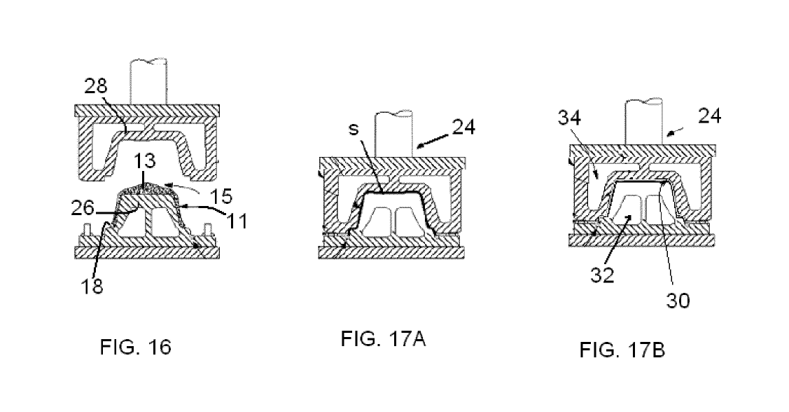

A method used would be sheet molding as seen in FIGS. 16 and 17A, 17B. A preferred process of making eating appliance 10 includes the steps of (a) providing a swatch of carbon fiber resin of a predetermined size; (b) inserting the swatch 11 of preformed carbon fiber resin in a shaping mold 24 having a male member 26 and a female member 28 which when operably connected to one another define a predetermined eating appliance shape S which defines an inner wall surface 30, and which is further characterized such that a peripheral edge 18 of the carbon fiber of the swatch 11 is generally maintained in a spaced relation relative to the inner wall surface 30;

(c) applying heat to the swatch 11 for a predetermined period while in the mold 24 to cause the swatch 11 to undergo a thermal reaction thereby causing resin 15 to thermally activate and expand from the carbon fiber 13 and contact the in the inner wall surface 30 such that the swatch 11 is permanently formed into the eating appliance shape S; and (d) removing the permanently formed eating appliance shaped swatch 11′ from the mold 24. In one embodiment, the peripheral edge 18 of the permanently formed eating appliance shaped swatch 11′ can be treated in a manner to provide the swatch 11′ with an enhanced edge 18′. This step is further characterized to include trimming the peripheral edge 18 by affixing reinforcing and or decorative member 20 to the peripheral edge 18 either during or after the molding process. If during, the member 20 can be placed adjacent the inner wall surface 30 prior heat application and the resin 15 can bond to member 20. If subsequent, the member 20 can alternatively be adhesively bonded to the peripheral edge 18, for example.

As mentioned, the reinforcing and or decorative member 20 can be a continuous loop member which can be a metal member, such as stainless steel. The reinforcing and or decorative member 20 can include a polished external surface 22. Emblem 24 can likewise include a polished surface.

The process can include the step of compressing the swatch 11 prior to performing step (c). The step (c) can be characterized to be heated to a temperature between about 200° C. to 400° C. for a period of about between 1 to 5 minutes. In this regard, veins 32 and 34 of molds 26 and 28, respectively can include means for heating the same.

It is contemplated that resin 15 can be added to a carbon fiber 13. Molds 26 and 28 can be coated previously with a release agent. In perform molding the reinforcing material in mat or fiber form (swatch 11) is preformed to the approximate shape and placed on one-half of the mold 26. Resin 15 can then be added to the perform swatch 11, the second half of the mold 28 is placed on the first half mold 26, and the two halves of the mold 24 are then pressed together and heated. The resin 15 flows, impregnates the perform swatch 11, and becomes hard. The cured part appliance shaped swatch 11′ is removed by opening the mold 24. Because pressures of up to 200 psi (14 kg/cm2) can be exerted upon the material to be molded, a higher ratio of glass to resin may be used, resulting in a stronger product. The cure time in the mold depends on the temperature, varying typically from 10 min at 1758° F. (808° C.) to only 1 min at 3008° F. (1508° C.). The cure cycle can thus be very short, and a high production rate is possible.

The molding of sheet-molding compounds (SMC) and dough-molding compounds (DMC) is done “dry”—i.e., it is not necessary to pour on resins. SMC, also called prepreg, can be a polyester resin mixture (containing catalyst and pigment) reinforced with chopped strand mat or chopped roving and formed into a pliable sheet that can be handled easily, cut to shape, and placed between the halves of the heated mold. The application of pressure then forces the sheet to take up the contours of the mold.

It is to be noted that care must be taken in the molding process to assure that the carbon fiber 13 is sized slightly less than the inner wall surface 30 and positioned and held generally in this set position as it is not desired to have carbon fiber extend from the exterior of the formed surface of appliance 10. Thus a generally smooth surface is provided.

The above described embodiments are set forth by way of example and are not limiting. It will be readily apparent that obvious modifications, derivations and variations can be made to the embodiments. Accordingly, the claims appended hereto should be read in their full scope including any such modifications, derivations and variations.

What is claimed is:

1. A process of making an eating appliance, which comprises the steps of:
(a) providing a swatch of carbon fiber resin of a predetermined size;
(b) inserting the swatch of preformed carbon fiber resin in a shaping mold having a male member and a female member which when operably connected to one another define a predetermined eating appliance shape which defines an inner wall, and which is further characterized such that a peripheral edge of the carbon fiber of said swatch is generally maintained in a spaced relation relative to said inner wall;
(c) applying heat to the swatch for a predetermined period while in said mold to cause said swatch to undergo a thermal reaction thereby causing resin to expand from said carbon fiber and contact said inner wall such that said swatch is permanently formed into said eating appliance shape; and
(d) removing said permanently formed eating appliance shaped swatch from said mold.

2. The process of claim 1, which further includes the step (e) of treating a peripheral edge of said permanently formed eating appliance shaped swatch in a manner to provide said swatch with an enhanced edge.

3. The process of claim 2, wherein said step (e) is further characterized to include affixing one of a reinforcing member and a decorative member to said peripheral edge.

4. The process of claim 3, wherein said member is a continuous loop member.

5. The process of claim 3, wherein said member includes a metal member.

6. The process of claim 5, wherein said member includes a polished external surface.

7. The process of claim 1, which includes the step of compressing said swatch prior to performing step (c).

8. The process of claim 1, which includes inserting one of a reinforcing member and a decorative member adjacent said inner wall surface of said mold to enable bonding with resin during step (c).

9. The process of claim 1, wherein step (c) is heated to a temperature between about 200° C. to 400° C. for a period of about between 1 to 5 minutes.

10. The process of claim 1, wherein said eating appliance includes one of a plate, platter, cup, saucer, vase, jar, bowl, breakfast set, tea set and dinner set.

11. An eating appliance, which comprises:
a swatch of a preformed carbon fiber resin of a predetermined size shaped and which is thermally permanently formed into an eating appliance shape in a manner to have a generally smooth resin formed outer surface and inner carbon fiber member and configured to have a concave portion having a bottom and upwardly extending wall portion which terminates into a peripheral edge.

12. The eating appliance of claim 11, wherein said carbon fiber member is a mat.

13. The eating appliance of claim 11, wherein said peripheral edge includes one of a reinforcing and decorative member affixed thereto.

14. The eating appliance of claim 13, wherein said member is a continuous loop member.

15. The eating appliance of claim 13, wherein said member includes a metal member.

16. The eating appliance of claim 13, wherein said member includes a polished external surface.

17. The eating appliance of claim 11, wherein said eating appliance includes one of a plate, platter, cup, saucer, vase, jar, bowl, breakfast set, tea set and dinner set.

18. The process of claim 1, wherein said members are coated with a release agent prior to performing step (b).

19. An eating appliance formed by the process as recited in claim 1.
